(19) United States
(12) Patent Application Publication
(10) Pub. No.: US 2025/0263255 A1
(43) Pub. Date: Aug. 21, 2025

(54) APPARATUS FOR TRANSFERRING POWDER

(71) Applicant: SK On Co., Ltd., Seoul (KR)

(72) Inventors: Yeong Jun JI, Daejeon (KR); Ji Yun YANG, Daejeon (KR); Joo Young JEONG, Daejeon (KR)

(21) Appl. No.: 18/954,543

(22) Filed: Nov. 21, 2024

(30) Foreign Application Priority Data
Feb. 15, 2024 (KR) 10-2024-0021982

(51) Int. Cl. B65G 65/02; B65G 53/24; H01M 4/04

(52) U.S. Cl. CPC B65G 65/02; B65G 53/24; H01M 4/04

(57) ABSTRACT

Proposed is an apparatus for transferring powder, the apparatus including a guide rail part extending horizontally on a container, a cutting part installed on the guide rail part and including a blade for cutting a portion of the container, an insert part installed on the guide rail part and expanding and opening a cut portion of the container, and a powder transfer part coupled to the insert part and suctioning and transferring the powder stored in the container.

### CROSS REFERENCE TO RELATED APPLICATION

The present application claims priority to Korean Patent Application No. 10-2024-0021982, filed Feb. 15, 2024, the entire contents of which is incorporated herein for all purposes by this reference.

### BACKGROUND OF THE INVENTION

### Field of the Invention

The present disclosure relates generally to an apparatus for transferring powder. More particularly, the present disclosure relates to an apparatus capable of suctioning a secondary battery powder-type active material accommodated in a container and transferring the powder-type active material to a subsequent process.

### Description of the Related Art

A secondary battery is a battery that performs charging and discharging, and generally includes a cathode coated with a cathode active material, an anode coated with an anode active material, a separator interposed between the cathode and the anode, and an electrolyte.

As is widely known to those skilled in the art, in a manufacturing process of a secondary battery, it is necessary to transfer and mix a powdery electrode active material including the aforementioned cathode active material or anode active material.

Patent Document 1 related to powder transfer was filed by the same applicant of the present disclosure on Mar. 6, 2019, and proposes an “Automatic Powder Transfer System Using a Vacuum Conveyor” that transfers powder used for product production to a downstream facility by a vacuum suction method while precisely controlling a powder transfer amount.

As described above, the conventional powder transfer systems focus on precisely controlling the amount of powder transferred, and therefore have limitations in transferring the entire amount of powder contained in the container to a subsequent process without loss.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent document 1) Korean Patent Application Publication No. 10-2020-0107146

### SUMMARY OF THE INVENTION

Accordingly, the present disclosure has been made keeping in mind the above problems occurring in the related art, and one objective of the present disclosure is to provide an apparatus for transferring powder, the apparatus being capable of easily transferring the entire amount of powder without scattering or loss during a process of transferring the powder to another location.

In order to achieve the above objective, according to one aspect of the present disclosure, there is provided an apparatus for transferring powder, the apparatus including: a guide rail part extending horizontally on a container; a cutting part installed on the guide rail part and including a blade configured to cut a portion of the container; an insert part installed on the guide rail part and including an expansion rod configured to expand and open a cut portion of the container; and a powder transfer part coupled to the insert part and configured to suction and transfer the powder stored in the container.

In the present disclosure, the cutting part may be installed so as to be travelable along the guide rail part and may include the blade configured to be movable up and down.

In the present disclosure, the insert part may be installed so as to be travelable along the guide rail part and may include the expansion rod configured to be movable up and down.

In the present disclosure, the apparatus may further include a pair of side pressurizing parts arranged oppositely at a predetermined interval below the guide rail part.

In the present disclosure, the apparatus may further include a container withdrawal part located below the guide rail part.

In one embodiment of the present disclosure, the cutting part may include: a traveling unit configured to be travelable along the guide rail part so that the blade is positioned above the container; a lifting unit including a cylinder disposed toward the container on the traveling unit; and the blade coupled to an end of a cylinder rod of the cylinder.

In one embodiment of the present disclosure, the lifting unit may further include a lift between the traveling unit and the cylinder.

Additionally, the lift may include: a pair of vertical bars extending vertically from opposite extension-direction ends of the traveling unit and arranged parallel to each other; and a support disposed to be movable up and down between the pair of vertical bars and configured to fix a position of the cylinder.

In one embodiment of the present disclosure, the insert part may include: a traveling unit configured to be travelable along the guide rail part so that the expansion rod is positioned above the cut portion of the container; a pair of cylinders arranged toward the container on the traveling unit; and the expansion rod coupled to an end of a cylinder rod of each of the pair of cylinders.

Preferably, the insert part may fix a position of an inlet end of the powder transfer part to the expansion rod.

The powder transfer part may include a hollow tube. Furthermore, the powder transfer part may include a penetration member disposed at an inlet end thereof entering an inside of the container.

Optionally, the penetration member may be formed in a shape that becomes sharper towards a tip thereof and may include a plurality of through-holes in an inner area thereof.

In the present disclosure, the container may include: an opening formed on an upper surface thereof; a plurality of segment panels configured to openably cover the opening; a main body having an inner space communicating with the opening and configured to accommodate the powder therein; and a cover configured to open and close the opening.

Additionally, the container may be formed in a shape in which a lower portion of the main body is tapered.

Optionally, the plurality of segment panels may be arranged around a circumference of the opening so that side edges thereof overlap each other.

The features and advantages of the present disclosure will be more clearly understood from the following detailed description when taken in conjunction with the accompanying drawings.

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the above description of the present disclosure, the present disclosure proposes an improved apparatus for transferring powder, the apparatus being capable of transferring the entire amount of powder to a subsequent processing facility while preventing scattering and/or loss of the powder.

The present disclosure is configured to allow the powder to be transferred by vacuum suction by seating the container storing the powder on the ground rather than transferring the powder by lifting the container and dropping the powder, and thus can provide a clean working environment.

In particular, the present disclosure can improve discharge of the powder remaining inside the container.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view schematically illustrating an apparatus for transferring powder according to an embodiment of the present disclosure;

FIG. 2 is a view schematically illustrating a process of introducing a container into the apparatus for transferring powder according to the embodiment of the present disclosure;

FIG. 3 is a view schematically illustrating a process of cutting the container using the apparatus for transferring powder according to the embodiment of the present disclosure;

FIG. 4 is a view illustrating a cut state of the container;

FIG. 5 is a view schematically illustrating a process of transferring powder contained in the container using the apparatus for transferring powder according to the embodiment of the present disclosure;

FIG. 6 is a view illustrating a state in which a powder transfer part penetrates into the container;

FIG. 7 is a view schematically illustrating a process of withdrawing the container from the apparatus for transferring powder according to the embodiment of the present disclosure; and

FIG. 8 is a perspective view schematically illustrating another example of a container to be applied to the apparatus for transferring powder according to the embodiment of the present disclosure.

### DETAILED DESCRIPTION OF THE INVENTION

The objectives, specific advantages, and novel features of the present disclosure will be more clearly understood from the following detailed description and preferable embodiments when taken in conjunction with the accompanying drawings, but the present disclosure is not necessarily limited thereto. Further, in the following description of the present disclosure, a detailed description of related known configurations or functions may be omitted to avoid obscuring the subject matter of the present disclosure.

The embodiments described herein and the accompanying drawings are not intended to limit the present disclosure to any specific embodiments. It will be understood that the present disclosure encompasses various modifications, equivalents, and/or alternatives of the embodiments.

As for reference numerals associated with parts in the drawings, the same components will be designated by the same reference numerals although the components are shown in different drawings, and similar components will be designated by similar reference numerals.

It will be understood that, although the terms “first”, “second”, etc. may be used only to distinguish one element from another element, these elements should not be limited by these terms. In the drawings, some components are exaggerated, omitted, or schematically illustrated, and the size of each component does not exactly reflect its real size.

Hereinbelow, an exemplary embodiment of the present disclosure will be described in detail with reference to the accompanying drawings.

The present disclosure is intended to guide contents, that is, powder, filled in a container to a subsequent processing facility (e.g., a storage tank, a hopper, etc.) for storage, mixing, or transfer, and is configured to discharge the powder from the container and feed it into the subsequent processing facility. Here, the powder may be an electrode active material processed into a granular or powdery form required for manufacturing a secondary battery, and the electrode active material includes a cathode active material or an anode active material.

Additionally, the present disclosure is configured to allow cutting of a portion of the container to discharge the powder from the container.

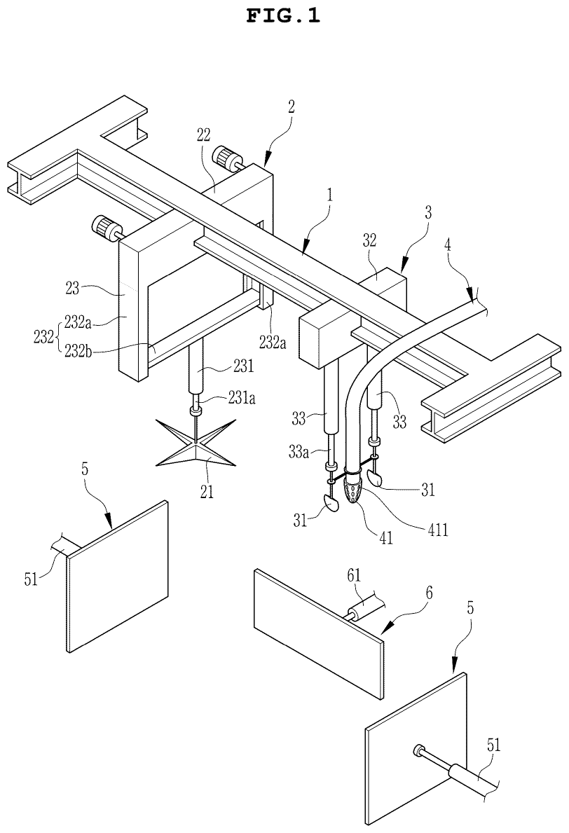

Referring to FIGS. 1 to 7, an apparatus for transferring powder according to an embodiment of the present disclosure includes: a guide rail part 1 extending horizontally on a container 7; a cutting part 2 installed on the guide rail part 1 and cutting a portion of the container 7; an insert part 3 installed on the guide rail part 1 and expanding and opening a cut portion of the container 7; and a powder transfer part 4 coupled to the insert part 3 and suctioning the powder stored in the container 7 and discharging the powder.

Additionally, the apparatus for transferring powder according to the embodiment of the present disclosure may include the cutting part 2 configured to induce an upward and downward operation of a blade 21 that cuts a portion of the container 7. Additionally, the cutting part 2 may be installed so as to be travelable along the guide rail part 1.

The apparatus for transferring powder according to the embodiment of the present disclosure may include the insert part 3 configured to induce an upward and downward operation of an expansion rod 31 that insertedly passes through a cut area cut by the blade 21. Furthermore, the insert part 3 may be installed so as to be travelable along the guide rail part 1.

For reference, the container 7 may be a packaging material widely used for the purpose of loading and transferring granular or powdery contents, and is also called a flexible container, a flexible bulk container, a ton bag, etc. Without being limited thereto, it will be apparent to those skilled in the art that the present disclosure is applicable to various types of containers capable of storing/transferring contents.

The guide rail part 1 may be a structural member that supports the insert part 3 so as to be travelable together with the aforementioned cutting part 2, and may be disposed horizontally at a predetermined height from the ground as illustrated. Preferably, the guide rail part 1 may be installed higher than the height of the container 7 filled with the powder so as to allow easy introduction or withdrawal of the container 7 into or from a space between the guide rail part 1 and the ground.

In the present disclosure, the guide rail part 1 may be disposed horizontally on a plurality of vertical frames (not illustrated) installed vertically on the ground, or alternatively, the guide rail part 1 may be installed horizontally on the ceiling of a workplace.

The present disclosure may include the cutting part 2 for cutting the portion of the container 7 positioned below the guide rail part 1. The cutting part 2 may be coupled to the guide rail part 1 so as to be travelable therealong and may include the blade 21 that is movable up and down in the vertical direction.

Specifically, the cutting part 2 may include a traveling unit 22 that positions the blade 21 movable up and down above the cut area of the container 7, and a lifting unit 23 that moves the blade 21 up and down in the vertical direction. In other words, the cutting part 2 may include the traveling unit 22 that is travelable along the guide rail part 1 to position the blade 21 above the container 7, the lifting unit 23 provided on the traveling unit 22 and including a cylinder 231 disposed toward the container 7, and the blade 21 coupled to an end of a cylinder rod 231a of the cylinder 231.

The cutting part 2 may be coupled to the guide rail part 1 by the traveling unit 22 and may be traveled along a guide path of the guide rail part 1. The traveling unit 22 may include a body extending in a direction orthogonal to the longitudinal direction of the guide rail part 1, a traveling wheel for moving the body on the guide rail part 1, and a driving means for rotating the traveling wheel. The driving means may control rotation of the traveling wheel that is moved in a rolling motion in contact with the guide rail part 1.

Optionally, the traveling unit 22 may be configured to secure precise traveling performance while being mounted on the guide rail part 1 in a rack-and-pinion manner. That is, in the present disclosure, the cutting part 2 may be traveled and moved along the guide rail part 1 by meshing a rack gear installed on an outer surface of the guide rail part 1 and a pinion gear rotationally driven in the body of the traveling unit 22. In the present disclosure, the traveling unit 22 is not limited to a specific form as long as it is a traveling device that is travelable while being coupled to the guide rail part 1.

As described above, the cutting part 2 may easily control vertical displacement of the blade 21 by means of the lifting unit 23. The lifting unit 23 may be fixedly coupled to a lower portion of the traveling unit 22 so as not to interfere with traveling of the traveling unit 22 while allowing the container 7 to face toward the blade 21.

In the embodiment of the present disclosure, the lifting unit 23 may include the cylinder 231. Preferably, the cylinder 231 may be a vertical cylinder having the cylinder rod 231a that is extendable and retractable in the up-down direction.

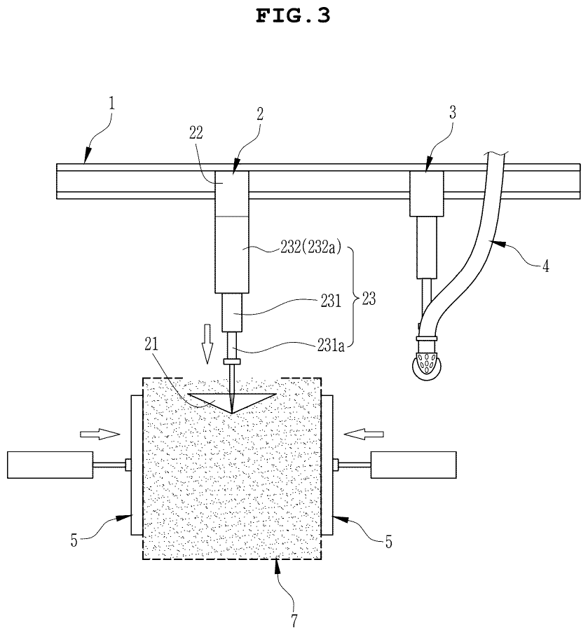

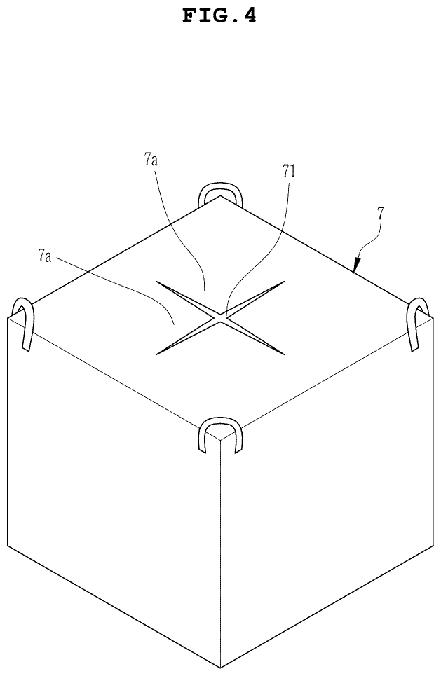

As illustrated, the blade 21 may be disposed at the end the cylinder rod 231a of the cylinder 231. As illustrated in FIG. 3, the cutting part 2 may form a cut portion 7a (see FIG. 4) on a portion (upper surface) of the container 7 by moving the blade 21 downward in an extension mode of the cylinder rod 231a. In the present disclosure, the cut portion 7a may be formed by at least partially cutting the upper surface of the container 7 along a cutting line formed in an inner area of the upper surface of the container 7 by contact of the blade 21 with the container 7.

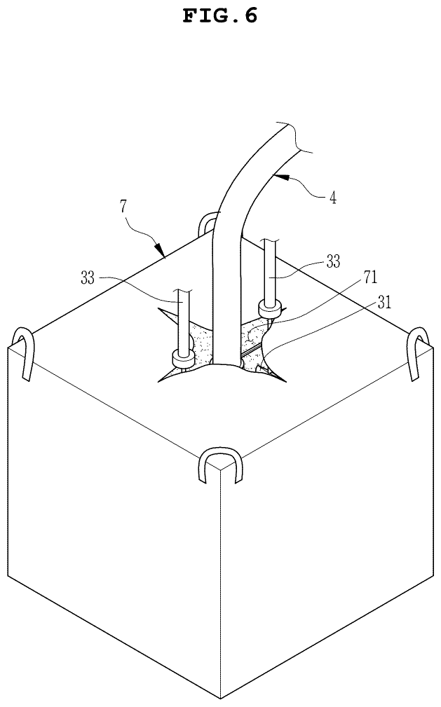

As described above, since the cutting line is formed by the blade 21 of the cutting part 2, the cutting line may be formed to correspond to the shape of a tip of the blade 21. The blade 21 may be formed in a sharp cross-shape at the tip thereof, but the present disclosure is not limited thereto, and any shape of blade that can provide a cutting line shape that allows smooth penetration of the powder transfer part 4 may be used. As illustrated in FIG. 4, the upper surface of the container 7 may be cut into four sides by the blade 21 to form four cut portions 7a. Meanwhile, as illustrated in FIG. 6, the cut portions 7a may be bent through downward insertion of the expansion rod 31 of the insert part 3 to maintain an opening 71 open to allow entry of the powder transfer part 4.

Of course, the cutting part 2 may separate the blade 21 from the upper surface of the container 7 by moving the blade 21 upward in a retraction mode of the cylinder rod 231a.

Additionally, the lifting unit 23 may further include a lift 232 for changing the position of the cylinder 231 in the up-down direction. Specifically, the lift 232 may be interposed between the traveling unit 22 and the cylinder 231.

The lift 232 may include a pair of vertical bars 232a extending vertically downward from opposite ends of the traveling unit 22, that is, opposite extension-direction ends of the traveling unit 22, and arranged parallel to each other, and a support 232b interposed between the pair of vertical bars 232a and movable up and down along longitudinal portions of the vertical bars 232a. The support 232b may fix the position of the cylinder 231 at a center lower portion thereof, and may be reciprocated up and down within the range of an extension length of the vertical bars 232a to adjust a height of the cylinder 231. For example, the support 232b may be disposed and coupled between a first chain disposed in one vertical bar 232a and a second chain disposed in the remaining vertical bar 232a, and the support 232b may be reciprocated up and down by the chains that are connected to a motor and rotated.

As a result, an operating range of the blade 21 may be expanded by arranging the cylinder 231 and the lift 232 in line in the vertical direction, thereby providing the advantage of easily changing the height of the cylinder 231 to enable the blade 21 mounted on the cylinder 231 to make contact with the upper surface of the container 7 of various sizes. Additionally, when the powder is agglomerated (or hardened) inside the container 7, the blade 21 may be inserted deep into the container 7 during the process of forming the cut portions 7a on the upper surface of the container 7, thereby crushing the hardened powder and easily transferring the powder to a subsequent processing facility.

Optionally, in the present disclosure, the lift 232 may be replaced with a cylinder disposed to be extendable and retractable in the up-down direction.

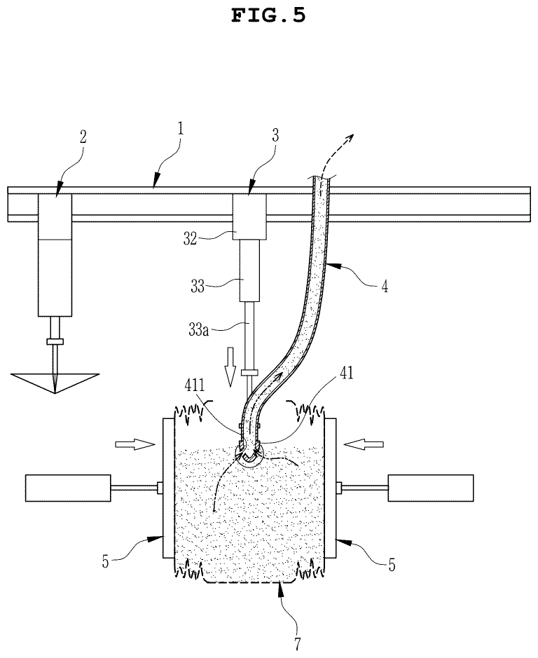

As illustrated in FIG. 5, the cut portions 7a formed on the upper surface of the container 7 may be opened by means of the insert part 3 to provide penetration of the powder transfer part 4.

The insert part 3 may bend the cut portions 7a to expand the cut portions 7a to an open state. In other words, in the present disclosure, the opening 71 that allows penetration of the powder transfer part 4 therethrough may be provided on one surface, for example, the upper surface, of the container 7 by bending and shaping the cut portions 7a toward an inner space of the container 7 with the expansion rod 31 through a downward insertion process of the insert part 3 illustrated in FIG. 5.

To this end, the insert part 3 may include a traveling unit 32 that positions a pair of expansion rods 31 spaced apart from each other at a predetermined interval above cut areas, that is, the cut portions 7a, of the container 7, and a pair of cylinders 33 extending vertically downward from the traveling unit 32 and arranged parallel to each other. In other words, the insert part 3 may include the traveling unit 32 that is travelable along the guide rail part 1 to position the pair of expansion rods 31 above the cut portions 7a of the container 7, the pair of cylinders 33 provided on the traveling unit 32 and disposed toward the container 7, and the pair of expansion rods 31 coupled to ends of a pair of cylinder rods 33a of the pair of cylinders 33, respectively. Of course, each of the pair of cylinders 33 may be a vertical cylinder having the cylinder rod 33a that is extendable and retractable in the up-down direction.

In the present disclosure, the position of an inlet end of the powder transfer part 4 may be fixed to the pair of expansion rods 31. Specifically, the inlet end of the powder transfer part 4 may be disposed and coupled between the pair of expansion rods 31. Alternatively, the inlet end of the powder transfer part 4 may be disposed and coupled between the pair of cylinder rods 33a. In the present disclosure, based on this arrangement structure of the insert part 3, the opening 71 may be secured by expanding the cut portions 7a with the pair of expansion rods 31 by the extension mode of the pair of cylinder rods 33a while allowing the inlet end of the powder transfer part 4 to enter the inside of the container 7.

In the present disclosure, the pair of expansion rods 31 may be arranged to be spaced apart from each other at a predetermined interval in the extension direction of the traveling unit 32 to maintain the cut portions 7a in an open state. Furthermore, the pair of expansion rods 31 may be spaced apart from each other at a predetermined interval so that the inlet end of the powder transfer part 4 is interposed therebetween.

In the embodiment of the present disclosure, the insert part 3 may be configured so that free ends (ends) of the pair of expansion rods 31 and the inlet end of the powder transfer part 4 are arranged at different heights. Accordingly, the inlet end of the powder transfer part 4 may enter the inside of the container 7 after the cut portions 7a are expanded and opened.

As illustrated, the powder transfer part 4 may include a hollow tube, and may include a hollow tube made of a flexible material. The powder transfer part 4 may transfer the powder stored in the container 4 to the subsequent processing facility.

Preferably, the powder transfer part 4 may have a penetration member 41 disposed at the inlet end thereof. For example, the penetration member 41 may be formed in a wedge shape that becomes sharper toward a tip thereof so that it easily penetrates into the inside of the container 7 through the opening 71, and may have a plurality of through-holes 411 in an inner area of the penetration member 41.

As is widely known to those skilled in the art, the powder transfer part 4 may be connected to a suction device (not illustrated) such as a vacuum pump, and the powder stored in the container 7 may be suctioned in a plurality of directions through the plurality of through-holes 411 of the penetration member 41 by a suction force generated by driving of the suction device, thereby improving fluidity of the powder. Since a method of transferring the powder is a known technology, a detailed description thereof will be omitted.

Optionally, in order to eliminate unnecessary collision between the cutting part 2 and the insert part 3 on the guide rail part 1, the cutting part 2 and the insert part 3 may be spaced apart from each other along the guide rail part 1 so as to maintain a predetermined set gap therebetween or may be traveled in a spaced state.

The present disclosure may further include a pair of side pressurizing parts 5 arranged oppositely and standing apart from each other at a predetermined interval. The pair of side pressurizing parts 5 may be plate-shaped structures arranged vertically on opposite sides of the container 7 that is to be positioned below the guide rail part 1. The pair of side pressurizing parts 5 may be arranged oppositely along the longitudinal direction of the guide rail part 1 as illustrated, or alternatively, may be arranged oppositely in a direction orthogonal to the longitudinal direction of the guide rail part 1.

For example, during a cutting process of the cutting part 2 and/or a process of transferring the powder downstream by vacuum suction of the powder transfer part 4, the pair of side pressurizing parts 5 may sustainably pressurize the opposite sides of the container 7 to support the container 7 so as to be maintained in a vertical state, thereby helping to discharge the entire amount of the powder inside the container 7.

Each of the pair of side pressurizing parts 5 may include an actuator 51 that brings the side pressurizing part 5 into close contact with or away from the side of the container 7. The actuator 51 may be a cylinder that reciprocates the side pressurizing part 5 horizontally.

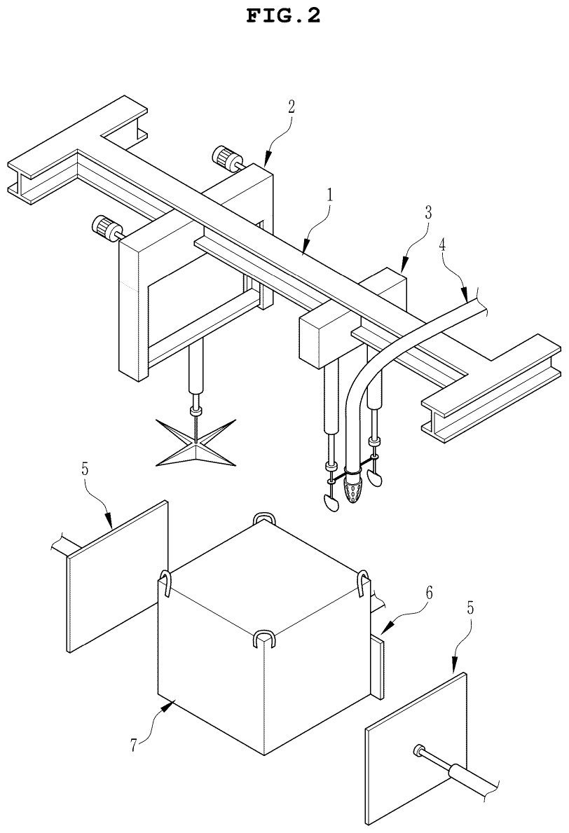

As illustrated in FIG. 2, the container 7 may be positioned below the guide rail part 1 to discharge the powder stored therein. This may be usually done by introducing a pallet (not illustrated) loaded with the container 7 into a space below the guide rail part 1, more specifically, a space defined by the guide rail part 1 and the pair of side pressuring parts 5, using an automated guided vehicle (AGV), a forklift, etc. Accordingly, the pair of side pressurizing parts 5 may be arranged at a predetermined height from the ground to eliminate the chance of contact with the pallet.

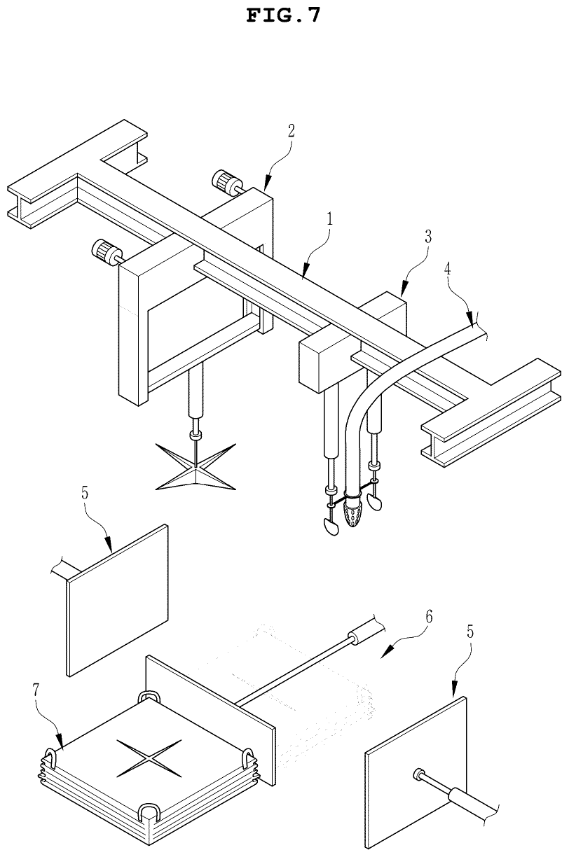

Additionally, the present disclosure may further include a container withdrawal part 6 that withdraws the container 7 positioned below the guide rail part 1 outward. The container withdrawal part 6 may be in the form of a plate-shaped structure, and as illustrated in FIG. 7, may be configured to push the container 7 from which the powder has been discharged outward from below the guide rail part 1. Accordingly, the apparatus for transferring powder according to the embodiment of the present disclosure may transfer additional powder by introducing a new container 7 below the guide rail part 1. Of course, the container withdrawal part 6 may include an actuator 61 that is reciprocable. The actuator 61 may be a cylinder.

In the present disclosure, the container withdrawal part 6 and the pair of side pressurizing parts 5 may be configured to be reciprocated below the guide rail part 1 without interfering with each other. For example, the container withdrawal part 6 may be disposed in a direction orthogonal to the pair of side pressurizing parts 5 or positioned lower than the height of the pair of side pressurizing parts 5.

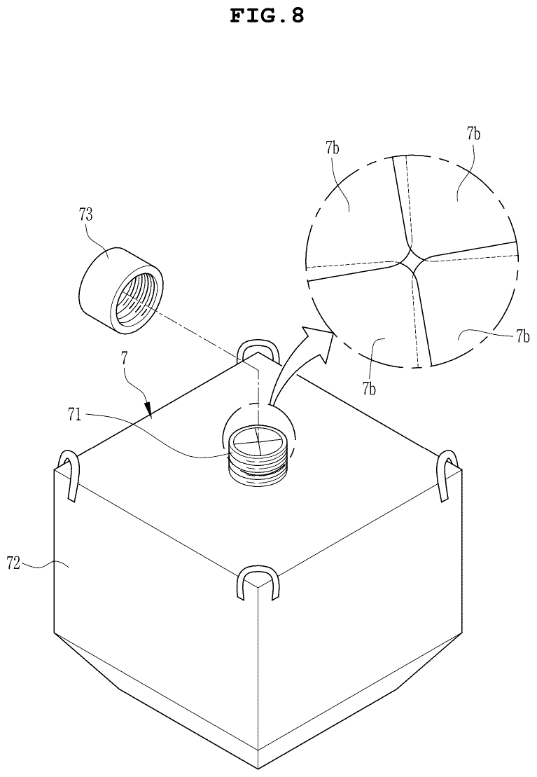

FIG. 8 is a perspective view schematically illustrating another example of a container 7 to be applied to the apparatus for transferring powder according to the embodiment of the present disclosure.

The container 7 may include an opening 71 formed on an upper surface thereof, a main body 72 that provides an inner space communicating with the opening 71 and accommodating powder therein, and a cover 73 that opens and closes the opening 71. In particular, the container 7 may include a plurality of segment panels 7b that openably cover the opening 71.

In the embodiment of the present disclosure, the container 7 may prevent unnecessary leakage (scattering) of the powder stored in the main body 72 by the cover 73. Preferably, the main body 72 may have a tapered lower portion, and may have a tapered shape in which an inner cross-section thereof gradually becomes smaller toward the lower portion thereof to easily achieve powder recovery.

Additionally, the main body 72 may be made of a material that has chemical resistance and can provide high quality maintenance of contents (e.g., powder). Additionally, in the present disclosure, the main body 72 may be made of a hard material so that the shape of the main body 72 is maintained regardless of a change in volume of the powder during a powder suction process.

The container 7 may be configured so that the opening 71 and the cover 73 are separated from or coupled to each other by a screw fastening method, but the present disclosure is not limited thereto, and any fastening method that allows the opening 71 to be opened and closed through the cover 73 may be used.

As illustrated, in the present disclosure, the opening 71 may be in the form of an annular frame structure, and the plurality of segment panels 7b may be arranged around the circumference of the opening 71. The plurality of segment panels 7b may be formed in a roughly triangular shape. Therefore, the plurality of segment panels 7b may be arranged along the circumferential direction of the opening 71 so that a side edge of one segment panel 7b and a side edge of another segment panel 7b adjacent thereto overlap each other. This arrangement structure allows penetration of the powder transfer part 4 by opening gaps between side edges of the overlapping segment panels 7b and bending the overlapping segment panels 7b downward so as to be separated from each other by a downward movement of the pair of expansion rods 31 of the insert part 3 and/or the penetration member 41 of the powder transfer part 4 illustrated in FIG. 1. When a pressure applied by the pair of expansion rods 31 and/or the powder transfer part 4 to the plurality of segment panels 7b arranged in the circumferential direction of the opening 71 is released, the plurality of segment panels 7b may be brought into close contact with each other while being deployed to their original positions by a restoring force of each segment panel 7b, thereby effectively blocking the opening 71. Each of the plurality of segment panels 7b may be made of flexible silicone or synthetic rubber.

The present disclosure has been described in detail through specific embodiments. The embodiments are intended to be used only for concretely describing the present disclosure, but the present disclosure is not limited thereto. It will be understood by those skilled in the art that the present disclosure can be modified or changed in various forms without departing from the technical spirit of the present disclosure.

Simple modifications or changes of the present disclosure belong to the scope of the present disclosure, and the detailed scope of the present disclosure will be more clearly understood by the accompanying claims.

What is claimed is:

1. An apparatus for transferring powder, the apparatus comprising:
a guide rail part extending horizontally on a container;
a cutting part installed on the guide rail part and comprising a blade configured to cut a portion of the container;
an insert part installed on the guide rail part and comprising an expansion rod configured to expand and open a cut portion of the container; and
a powder transfer part coupled to the insert part and configured to suction and transfer the powder stored in the container.

2. The apparatus of claim 1, wherein the cutting part is installed so as to be travelable along the guide rail part and comprises the blade configured to be movable up and down.

3. The apparatus of claim 1, wherein the insert part is installed so as to be travelable along the guide rail part and comprises the expansion rod configured to be movable up and down.

4. The apparatus of claim 1, further comprising:
a pair of side pressurizing parts arranged oppositely at a predetermined interval below the guide rail part.

5. The apparatus of claim 1, further comprising:
a container withdrawal part located below the guide rail part.

6. The apparatus of claim 1, wherein the cutting part comprises: a traveling unit configured to be travelable along the guide rail part so that the blade is positioned above the container;
a lifting unit comprising a cylinder disposed toward the container on the traveling unit; and
the blade coupled to an end of a cylinder rod of the cylinder.

7. The apparatus of claim 6, wherein the lifting unit further comprises a lift between the traveling unit and the cylinder.

8. The apparatus of claim 7, wherein the lift comprises:
a pair of vertical bars extending vertically from opposite extension-direction ends of the traveling unit and arranged parallel to each other; and
a support disposed to be movable up and down between the pair of vertical bars and configured to fix a position of the cylinder.

9. The apparatus of claim 1, wherein the insert part comprises: a traveling unit configured to be travelable along the guide rail part so that the expansion rod is positioned above the cut portion of the container;
a pair of cylinders arranged toward the container on the traveling unit; and
the expansion rod coupled to an end of a cylinder rod of each of the pair of cylinders.

10. The apparatus of claim 1, wherein the insert part fixes a position of an inlet end of the powder transfer part to the expansion rod.

11. The apparatus of claim 1, wherein the powder transfer part comprises a hollow tube, and
the powder transfer part comprises a penetration member disposed at an inlet end thereof entering an inside of the container.

12. The apparatus of claim 11, wherein the penetration member is formed in a shape that becomes sharper towards a tip thereof and comprises a plurality of through-holes in an inner area thereof.

13. The apparatus of claim 1, wherein the container comprises:
an opening formed on an upper surface thereof;
a plurality of segment panels configured to openably cover the opening;
a main body having an inner space communicating with the opening and configured to accommodate the powder therein; and
a cover configured to open and close the opening.

14. The apparatus of claim 13, wherein the container is formed in a shape in which a lower portion of the main body is tapered.

15. The apparatus of claim 13, wherein the plurality of segment panels are arranged around a circumference of the opening so that side edges thereof overlap each other.
